(19) United States
(12) Patent Application Publication
(10) Pub. No.: US 2025/0365772 A1
(43) Pub. Date: Nov. 27, 2025

(54) Method for LTM Mechanism Design

(71) Applicant: ZTE Corporation, Shenzhen (CN)

(72) Inventors: Fei DONG, Shenzhen (CN); Jing LIU, Shenzhen (CN); He HUANG, Shenzhen (CN); Mengjie ZHANG, Shenzhen (CN)

(73) Assignee: ZTE Corporation, Shenzhen (CN)

(21) Appl. No.: 19/287,426

(22) Filed: Jul. 31, 2025

Related U.S. Application Data
(63) Continuation of application No. PCT/CN2023/111310, filed on Aug. 4, 2023.

(51) Int. Cl. H04W 74/0833; H04W 52/36; H04W 56/00; H04W 72/231; H04W 76/20

(52) U.S. Cl. CPC H04W 74/0833; H04W 52/36; H04W 56/0045; H04W 72/231; H04W 76/20

(57) ABSTRACT

Methods, devices, and systems for providing early timing advance (TA) acquisition are provided. A radio resource control (RRC) configuration of the early TA acquisition is received from a base station. A PDCCH order to trigger a random access channel (RACH) procedure toward a candidate cell is received from the base station. The RACH procedure for the early TA acquisition is initiated based on the received RRC configuration and PDCCH order. A preamble with a calculated transmission power on the candidate cell is transmitted to the base station.

### TECHNICAL FIELD

The present subject matter is directed generally to wireless communications. Particularly, the present subject matter relates to methods, devices, and systems for implementing a Random Access Channel (RACH) procedure toward an L1/L2 Triggered Mobility (LTM) candidate cell, how a User Equipment (UE) should process an uplink (UL) grant (i.e., dynamic grant (DG)/configured grant (CG)) for transmitting a Dedicated Control Channel (DCCH) message, and how the UE should maintain a Timing Advance (TA) value during LTM.

### BACKGROUND

Prior efforts in LTM (i.e., L1/L2 Triggered Mobility) for obtaining the UL synchronization before performing cell switch involved introducing the early RACH procedure to reduce the delay of the handover. The early RACH procedure may not include the step of Random Access Response (RAR). That is, only the step of preamble transmission, without any feedback signaling, may be used for judging whether the RACH is successful or not. This approach is different from the current RACH procedure. In accordance with the present subject matter, the features of the one-step RACH procedure will be described.

The TA for candidate cells before cell switch may be maintained during LTM. However, in the legacy implementation, the TA would be considered invalid during the LTM. In accordance with the present subject matter, how a UE may maintain the TA value during the LTM will be described.

The RACH-less LTM may be supported for both inter-distributed unit (DU) LTM and intra-distributed unit (DU) LTM, meanwhile, both configured grant (CG) and dynamic grant (DG) may be used for transmitting the DCCH message (i.e., RRCReconfigurationComplete) to notify the target cell of the UE arriving. In accordance with the present subject matter, how a UE may utilize the CG and/or DG to transmit the DCCH message will be described, as well as the associated advantages.

### SUMMARY

The present subject matter is directed to a method, device, and system for implementing a Random Access Channel (RACH) procedure toward an L1/L2 Triggered Mobility (LTM) candidate cell, how a User Equipment (UE) should process an uplink (UL) grant (i.e., dynamic grant (DG)/configured grant (CG)) for transmitting a Dedicated Control Channel (DCCH) message, and how the UE should maintain a Timing Advance (TA) value during LTM.

In some embodiments, a method for providing early timing advance (TA) acquisition includes receiving, from a base station, a radio resource control (RRC) configuration of the early TA acquisition; receiving, from the base station, a PDCCH order to trigger a random access channel (RACH) toward a candidate cell; initiating the RACH procedure for the early TA acquisition based on the received RRC configuration and PDCCH order; and transmitting, to the base station, a preamble with a calculated transmission power on the candidate cell.

In some embodiments, a method for providing early timing advance (TA) acquisition in a User Equipment (UE) includes receiving, from a source cell, a L1/L2 Triggered Mobility (LTM) Cell Switch MAC CE; determining TA values to be maintained during the LTM and performing the corresponding operation; and transmitting to a target cell with the maintained TA value.

In some embodiments, a method for providing an uplink (UL) grant for a Dedicated Control Channel (DCCH) message includes receiving a Radio Resource Control (RRC) configuration of L1/L2 triggered mobility (LTM) from a source cell; receiving an LTM Cell Switch Command MAC CE from the source cell; applying the RRC configuration of an LTM candidate cell indicated by the LTM Cell Switch Command MAC CE; generating an DCCH message in response to the RRC configuration of the LTM candidate cell; transmitting a very first transmission to a target cell; and determining that LTM is successfully complete.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example wireless communication system including a wireless base station/gNB 200 and user equipment (UE) 300.

FIG. 2 shows an example of a base station/gNB 200.

FIG. 3 shows an example of a UE 300.

FIG. 4 shows an Early TA acquisition (e.g., RACH procedure) flow between a UE 300 and a gNB 200.

FIG. 5 shows a TA management flow between a UE 300, a source cell 501, and a target cell 502.

FIG. 6 shows a UL Grant flow for a DCCH message between a UE 300, a source cell 501, and a target cell 502.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless communication system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless communication system 100, the communication nodes are configured to wirelessly communicate signals between each other. In general, a communication in the wireless communication system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless communication system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the wireless communication system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

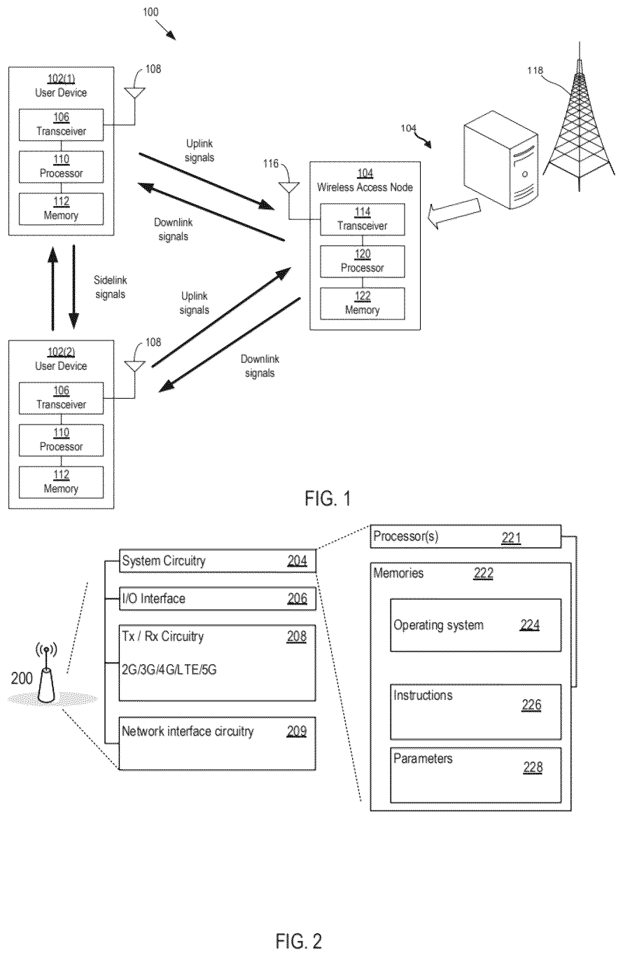

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

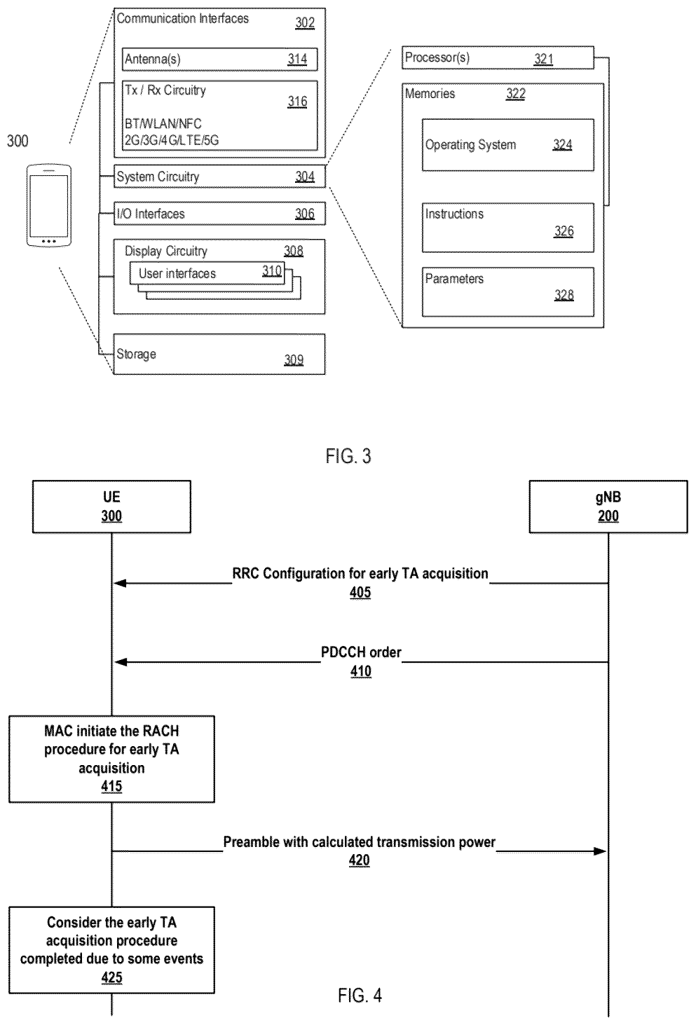

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers, and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

FIG. 4 shows a swim lane diagram of an early TA acquisition (e.g., RACH procedure). In step 405, the network (e.g., gNB 200) may send a Radio Resource Control (RRC) configuration of early TA acquisition to the UE 300. The gNB 200 may subsequently send a PDCCH Order to the UE 300 to trigger the early TA acquisition (e.g., RACH) for a candidate cell in step 410. In step 415, the MAC entity of the UE 300 may initiate a RACH procedure for early TA acquisition according to the received RRC configuration in step 405 and PDCCH order of step 410. In step 420, the UE 300 may send the preamble to the gNB 200 with a certain calculated transmission power (i.e., preambleReceiverTargetPower, which will be subsequently described). In step 425, the UE 300 may consider the early TA acquisition (e.g., the RACH procedure) completed according to some events, as will be subsequently described with further reference to step 425.

The early RACH procedure may be implemented according to any of four options. In an Option 1, the RACH procedure may be a cell-specific, single-shot RACH procedure. In an Option 2, the RACH procedure may be a cell-specific, multi-round RACH procedure. In an Option 3, the RACH procedure may be a MAC-specific, single-shot RACH procedure. In an Option 4, the RACH procedure may be a MAC-specific, multi-round RACH procedure.

In step 405, the RRC configuration of early TA acquisition may be implemented as shown below:

```
  EarlyUlSyncConfig-r18 ::= SEQUENCE {
    early-rach-ConfigGeneric-r18 Early-Rach-ConfigGeneric -r18
    ssb-perRACH-Occassion ENUMERATED
    {oneEighth, oneFourth, oneHalf, one, two, four, eight, sixteen}
  ...,
  }
  Early-RACH-CofigGeneric- r18 ::= SEQUENCE{
    prach-ConfigurationIndex INTEGER (0..255),
    msg1-FDM ENUMERATED {one, two, four, eight},
    msg1-FrequencyStart INTEGER
    (0..maxNrofPhysicalResourceBlocks-
    1),
    zeroCorrelationZoneConfig INTEGER(0..15),
    preambleReceivedTargetPower INTEGER (−202..−60),
    powerRampingStep ENUMERATED {Db0, Db2, Db4, Db6}
  ...,
}
```

In one implementation, the RRC parameter earlyULSyncConfig may be configured in each candidate cell configuration of RRC configuration for the LTM. In one implementation, the earlyULSyncConfig can be absent in a candidate cell configuration, the absence of the earlyULSyncConfig means the RACH procedure for early TA acquisition is not supported for the candidate cell.

In step 410, the PDCCH order transmitted from the gNB 200 may include at least one of the following information:
a. transmission type indication, to indicate the preamble transmission triggered by the PDCCH order is a retransmission or initial transmission.
b. preamble ID, to indicate the preamble index used for the RACH procedure for early TA acquisition.
c. Candidate Cell Id: to indicate the candidate cell where the RACH procedure for early TA acquisition shall be performed.
d. SSB Id: to indicate the Quasi-Colocation (QCL) relationship of the preamble transmission.
e. PRACH MASK Id: to indicate the RACH occasion (e.g. RO) for the preamble transmission.

In step 415, in one implementation of the initiation of the RACH procedure for early TA acquisition may introduce a new cell-specific UE variable for the RACH procedure for early TA acquisition, “LTM_PREAMBLE_POWER_RAMPING_COUNTER.” If the PDCCH order for triggering a RACH toward an LTM candidate cell is received, and the initial transmission of the preamble is indicated, the LTM_PREAMBLE_POWER_RAMPING_COUNTER for the indicated candidate cell may be set to “1”; If the PDCCH order for triggering a RACH toward an LTM candidate cell is received, and the retransmission of preamble is indicated, the LTM_PREAMBLE_POWER_RAMPING_COUNTER for the indicated candidate cell may keep the current value as it is.

In another implementation of the initiation of the RACH procedure for early TA acquisition may introduce a new MAC specific UE variable for the RACH procedure for early TA acquisition, “LTM_PREAMBLE POWER RAMPING COUNTER.” If the PDCCH order for early TA acquisition toward an LTM candidate cell is received, and the initial transmission of the preamble is indicated, the LTM PREAMBLE POWER_RAMPING_COUNTER may be set to “1”; If the PDCCH order for early TA acquisition toward an LTM candidate cell is received, and the retransmission of the preamble is indicated, and the LTM candidate cell is the same one for the previous RACH for the early TA acquisition, the LTM_PREAMBLE_POWER_RAMPING_COUNTER may keep the current value as it is.

In step 420, in an implementation of the preamble transmission: If the RACH is initiated by the PDCCH order for the LTM candidate cell, and the preamble transmission is indicated as a retransmission, then the LTM_PREAMBLE_POWER_RAMPING_COUNTER associated with the LTM candidate cell may be incremented by 1. The LTM_PREAMBLE_RECEIVED_TARGET_POWER of the LTM candidate cell for preamble transmission may be set to:

preambleReceiverTargetPower + DELTA_PREAMBLE +
(LTM_PREAMBLE_POWER_RAMPING_COUNTER − 1) ×
PREAMBLE_POWER_RAMPING_STEP +
POWER_OFFSET_2STEP_RA.

In this case, the POWER_OFFSET_2STEP_RA may be ignored or set to 0 dB. The physical layer may be instructed to transmit the Random Access Preamble using the selected PRACH occasion, corresponding Random Access Radio Network Temporary Identifier (RA-RNTI) (if available), PREAMBLE_INDEX, and LTM_PREAMBLE_RECEIVED_TARGET_POWER.

Alternatively, or in addition, in the preamble transmission of step 420, if the RACH is initiated by the PDCCH order toward the LTM candidate cell for early TA acquisition, and the previous RACH is initiated by the PDCCH order toward the same LTM candidate cell for early TA acquisition, then the PREAMBLE_POWER_RAMPING_COUNTER may be incremented by 1. The PREAMBLE_RECEIVED_TARGET_POWER of the LTM candidate cell may be set to:

preambleReceivedTargetPower + DELTA_PREAMBLE +
(PREAMBLE_POWER_RAMPING_COUNTER − 1) ×
PREAMBLE_POWER_RAMPING_STEP + POWER_OFFSET_2STEP_RA.
In this case, the POWER_OFFSET_2STEP_RA may be ignored or set to 0 dB. The
physical layer maybe instructed to transmit the Random Access Preamble using the
selected PRACH occasion, corresponding RA-RNTI (if available),
PREAMBLE_INDEX, and PREAMBLE_RECEIVED_TARGET_POWER.

In step 425, an implementation may consider whether the early RACH is a single-shot procedure. In this case, the RACH may be considered complete once the preamble transmission is instructed to the lower (physical) layer.

Alternatively, or in addition, step 425 may consider whether the early RACH is a multi-round procedure. In this case, the RACH may be considered complete in each of the following example cases. In an implementation, all RACH procedures or the RACH procedure for early TA acquisition may be considered complete if an LTM Cell switch MAC CE to trigger LTM is received. Alternatively, or in addition, all RACH procedures or the RACH procedure for early TA acquisition may be considered complete if the legacy RACH is triggered, in this implementation, the legacy RACH may be the RACH procedure not for early TA acquisition. Alternatively, or in addition, an early RACH procedure toward an LTM candidate cell is considered complete if another early RACH procedure toward a different LTM candidate cell is triggered. Alternatively, or in addition, the early RACH procedure toward an LTM candidate cell may be considered complete if the RRC configuration of the LTM candidate cell is released.

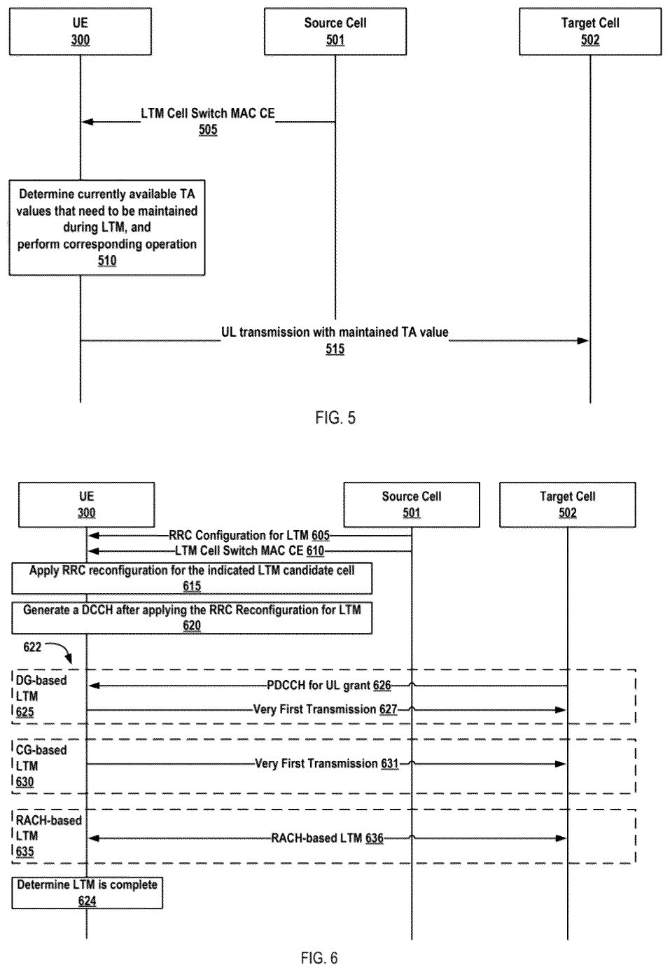

The subsequent description concerns Timing Advance (TA) management with reference to FIG. 5. In step 505, one LTM Cell switch MAC CE may be received by a UE 300 from a source cell 501. In step 510, the UE 300 may determine the current available TA values needed to be preserved or maintained during the LTM and perform the corresponding operation. In step 515, the UE 300 may perform the UL transmission to target cell(s) 502 with the preserved TA value.

During step 510, to identify the current available TA values may be maintained, the following options may be considered.

In a first option, the valid TAs of all serving cell(s) or all TAGS (e.g., before the cell switch) at the UE side may be maintained during LTM. In an implementation of the first option, in the case of the RACH-based LTM being triggered, the valid TAs of all serving cells or all TAGs may not be maintained, in this implementation, UE may consider TATs (e.g. timeAlignmentTimer) of all TAGs (e.g. Time Alignment Group) are considered expired. In the case of the RACH-less LTM being triggered, the valid TAs of all serving cells or all TAGs may be maintained during LTM.

In a second option, the valid TAs of the serving cells and/or TAGs after cell switch may be indicated by the source cell. In an implementation of the second option, the indication of the TA values and corresponding TAGs may be carried in the LTM Cell Switch MAC CE sent by source cell. In this implementation, the LTM Cell switch MAC CE may include at least one of the following fields: 1) TAGi field: Indicate the TAG Id for the i-th TAG for which the TA value is present; in one implementation, the TAGi field maybe a bitmap-like field; and 2) TAi field: the absolute TA value for the i-th TAG.

Alternatively, or in addition for the second option, the indication of the TA values may be associated with a TAG obtained from the RRC signaling and/or the LTM Cell Switch MAC CE. An example follows below:

```
  ltm-Reserved-TA-valuesToAddModList
  SEQUENCE(size(1...maxNrofTAGs) OF TA-Indication-r18 OPTIONAL, --
  Need N
  ltm-Reserved-TA-valuesToReleaseList
  SEQUENCE(size(1...maxNrofTAGs) OF ta-Indication-Id-r18 OPTIONAL, -
  -Need N
  ...
  }
```

| | |
|---|---|
| ta-Indication-r18 | SEQUENCE |
| ta-Indication-Id-r18 | INTEGER (1,2,3,4) |
| tag-Id | INTEGER (1,2,3,4), |
| TA | ENUMERATE(...) |

}

During the step 510, in one implementation of operation for the first option, the maintained TA value may be re-associated with a second TAG after cell switch via a serving cell that also belongs to a first TAG before cell switch. In one implementation of operation for the first option, the reassociation of maintained TA value to the TAG may be performed when receiving the LTM Cell switch MAC CE. In another implementation of operation for the first option, the reassociation of maintained TA value may be performed when LTM is considered as complete.

During the step 510, in one implementation of operation for the second option, the TA values may be associated with a TAG according to either LTM Cell Switch MAC CE or RRC signaling received from source cell. In one implementation of operation for the second option, the association of the TA value to the TAG may be performed when receiving the LTM Cell switch MAC CE. In another implementation of operation for the second option, the association of the TA value may be performed when LTM is considered as complete.

Regarding the time alignment timer (TAT) timer handling in step 515, two options may be provided. In a first option, if one cell belongs to the first TAG before cell switch and belongs to the second TAG after cell switch, the TAT associated with the first TAG may be re-associated with the second TAG when receiving LTM Cell switch MAC CE or upon the completion of LTM. Alternatively, or in addition, the TAT associated with the second TAG may start/restart with the remaining values of the TAT associated with the first TAG the same cell belongs to when receiving LTM Cell switch MAC CE or upon the completion of LTM. In a second option, the TAT may be started/restarted for each TAG when applying the TA value for the TAG indicated by either the LTM Cell Switch MAC CE or RRC signaling received from the source cell.

The subsequent description concerns the UL grant for the a very first transmission for LTM with reference to FIG. 6. In one implementation, a very first transmission 627/631 for LTM may be a transmission with DCCH Message. In one implementation, the DCCH message may be an RRC message, RRCReconfigurationComplete. In step 605, the UE 300 may receive the RRC configuration of LTM from a source cell 501. In step 610, the UE 300 may receive the LTM Cell Switch MAC CE from the source cell 501. In step 615, the UE 300 may apply the RRCReconfiguration message contained in the RRC configuration of LTM for the LTM candidate cell indicated by the LTM Cell Switch MAC CE. In step 620, the UE 300 may generate the DCCH message if successfully applying the RRCReconfiguration message. In step 622, the UE 300 may perform a very first transmission 627/631 with DCCH message for LTM according to any of the following alternatives (625, 630, 635) according to the RRC configuration of LTM and received LTM Cell Switch MAC CE: (1) the UE 300 may perform a very first transmission 627 with DCCH message for LTM to the target cell 502 with a dynamic grant (DG) (i.e., step 625); (2) the UE 300 may perform a very first transmission 631 with DCCH message for LTM to the target cell 502 with a configured grant (CG) (i.e., step 630); and/or (3) the UE 300 may initiate the RACH for LTM (i.e., step 635). In step 624, the UE 300 may determine the LTM is completed by at least one of the following cases: 1) Receiving a PDCCH addressed to C-RNTI for a new transmission; 2) Receiving a MAC CE with a DL transmission which indicates the LTM is successfully is terminated; in this implementation, the MAC CE may only contain subheader field without any payload; 3) Receiving a PDCCH addressed to C-RNTI for a new UL transmission with a same HARQ process Id for which the very first transmission 627/631 is performed. and/or 4) The RACH procedure is successfully complete.

In one implementation of the very first UL transmission 627/631, the very first UL transmission may be an initial transmission for LTM with DCCH message.

In step 605, one or more ConfiguredGrantConfig(s) may be contained in the RRC configuration of LTM for each candidate cell. The ConfiguredGrantConfig may be a configuration of a number of predefined UL grant resources that can be used for UL data transmission (e.g. the very first transmission 627/631 with the DCCH message) when performing LTM cell switch. Each CG occasion predefined in ConfiguredGrantConfig may be associated with one or more beams, which may be indicated by using the SSB Id.

In an implementation, the UL grant resource assigned by configuredGrantConfig for LTM may only be used for sending the DCCH message in order to avoid the potential UP data loss. In this implementation, one new LCH restriction parameter preAllocatedULGrant-allowed may be introduced in the logicalChannelConfig, In one implementation of preAllocatedULGrant-allowed, if the UL grant is assigned by the ConfiguredGrantConfig for LTM, only data (e.g., UL MAC SDUs) from the logical channel that is configured with pre-AllocatedULGrant-allowed may be multiplexed and assembled into a UL grant assigned by the ConfiguredGrantConfig for LTM. In one implementation of preAllocatedULGrant-allowed, it may only be optionally configured in the LCH associated with SRB1; it should be absent for the LCH associated with radio bearer other than the SRB1.

In an implementation, the UL grant resource assigned by ConfiguredGrantConfig for LTM may not be allowed to send the new UL data transmission subsequent to the very first UL transmission 627/631 if the very first UL transmission 627/631 for LTM has been initially performed and the LTM procedure is not considered as successfully completed. In one implementation The UL grant assigned by the ConfiguredGrantConfig for LTM may be ignored if the very first UL transmission has been sent, and the LTM procedure has not been considered by UE as completed.

In step 622, steps 625 and/or 630 may be allowed to fall back to step 635. A timer LTM-FallbackTimer may be introduced for each LTM candidate cell. Alternatively, or in addition, a timer LTM-FallbackTimer may be introduced in LTM-Config. The LTM-FallbackTimer may be a timer that is controlled by the MAC layer. Alternatively, or in addition, the LTM-FallbackTimer may be started at the last symbol of the PUSCH transmission for the initial transmission of the very first UL transmission for LTM. The LTM-FallbackTimer may be stopped by the completion of the LTM as determined by the UE 300 (e.g. step 624). The RACH-based LTM 636 may be triggered toward the target candidate LTM cell once the LTM-FallbackTimer expires. The length of the LTM-FallbackTimer may be shorter than the LTM supervision timer in RRC. The fallback from step 625 to step 635 may be triggered by a PDCCH order. The fallback from step 630 to 635 may be triggered by a COUNTER, where the COUNTER may count the number of the transmission times of the Transport Block (TB) of the very first UL transmission. In this implementation, a COUNTER threshold value may be configured for each LTM candidate cell. The COUNTER may be implemented according to at least one of the following: 1) For each instance of the very first UL transmission with DCCH message, the COUNTER value may be incremented by 1; 2) If the counter value is equal to or greater than the threshold value, the process may fallback to the RACH procedure; 3) the COUNTER may be set to 0 or 1 if the LTM is successfully completed.

If the fallback from step 625 and/or step 630 to step 635 is determined to be performed, at least one of the following operations may be performed: (1) reset the MAC entity and/or flush all the UL HARQ buffer and/or consider the TA of all TAGs as expired; (2) notify the upper layer of the fallback to the RACH-based LTM 636. In one implementation, a supervisor timer for LTM may be started or restarted by this notification from the lower layer (e.g., the MAC layer). The supervisor timer may be used for the UE 300 to determine whether the LTM is successfully completed or not. The expiration of supervisor timer may indicate the LTM is not successful. In one implementation, RRC may regenerate the RRCReconfigurationCompleteMessage if receiving the fallback indication from lower layer. Finally, fallback from step 625 and/or step 630 to step 635 may also include (3) initiating the RACH procedure toward the LTM candidate cell.

Regarding step 625 and/or step 630, either CG or DG may be used for transmission of the DCCH message (627/631) (e.g., RRCReconfigurationComplete), which may depend on whether the available DG or available CG arrives earlier. If the dynamic Uplink grant is used for an initial transmission of the very first UL transmission 627/631, the UL grant predefined by ConfiugredGrantConfig for LTM may be ignored by the MAC entity.

Regarding step 630, when selecting the CG occasion for the CG for LTM, the procedure may be carried out as subsequently described.

Assuming that the CG occasion predefined by ConfiguredGrantConfig for LTM has been associated with one or more beams and the LTM Cell Switch MAC CE received by UE (e.g. as step 610) also includes the beam indication for LTM, the UE 300 may consider only the CG occasion associated with the beam indicated by the LTM Cell switch MAC CE as valid for the very first UL transmission (e.g., the initial transmission for LTM cell switch with the DCCH message 631).

If the measurement result of RSRP of the beam indicated in the LTM Cell switch MAC CE is less than a predefined threshold, and at least one beam exists whose RSRP value exceeds the predefined threshold, the UE 300 may select one beam that exceeds the RSRP value and consider the corresponding CG occasion valid for the very first UL transmission 631.

If the measurement result of RSRP of the indicated beam by the LTM Cell switch MAC CE exceeds a predefined threshold value, the corresponding CG occasion may be considered valid for the very first UL transmission 631.

If there are no SSBs the CG occasion associated with having an RSRP value that exceeds a predefined threshold, the UE 300 may select the CG occasion associated with the beam indicated by LTM Cell switch MAC CE for the very first UL transmission. Alternatively, or in addition, the UE 300 may randomly choose an SSB Id and use the corresponding CG occasion for sending the very first UL transmission. Alternatively, or in addition, the UE 300 may determine to fallback to the STEP 635 RACH based LTM.

Assuming no association between CG occasion(s) and beams, and that the beam indication is included in the LTM Cell switch MAC CE, the closest CG occasion after cell switch may be considered valid for the very first UL transmission 631.

Regarding step 630, if the automatic (re) transmission of the very first UL transmission with the CG is allowed, the following steps may be performed.

In a first step, the UE 300 may decide the validity of each CG occasion of the CG for automatic (re)transmission of the very first UL transmission. The CG occasion for the automatic (re)transmission may be considered valid with one or more of the following options: (1) the CG occasion associated with an SSB Id that is the same as for the initial transmission; (2) the CG occasion associated with an SSB Id for which the RSRP measurement result exceeds the predefined threshold; and/or (3) the CG occasion associated with a same HARQ process ID as the initial transmission.

In a second step, for each valid CG occasion of the CG, the UE 300 may process the UL grant for automatic retransmission of the very first UL transmission 631. The automatic retransmission of the very first transmission with a configured UL grant may be supported. A re-transmission timer (e.g., LTMCGRetransmissionTimer) may be introduced in the ConfiguredGrantConfig in the RRC configuration of the LTM candidate cell configuration. If such a timer is configured, the timer may indicate the automatic retransmission of the very first UL transmission with the CG is supported. For each CG, the UE 300 may consider the New Data Indicator (NDI) value of the CG as not toggled if: (1) the LTMCGRetransmissionTimer is configured and not running; (2) if the ConfiguredGrantTimer is running; and (3) if the previous CG with the same HARQ process ID is for sending the very first UL transmission for LTM.

Alternatively, or in addition, in the second step, the automatic transmission of the very first transmission may be considered a new transmission. In this case, one enumerate type parameter automaticTx-LTM may be introduced in the ConfiguredGrantConfig. When this parameter is present with a value of true, automatic transmission of the very first UL transmission is allowed. For each valid UL grant, the HARQ entity of the UE 300 may consider the MAC PDU for the HARQ process ID as obtained, deliver the MAC PDU and the UL grant and the HARQ information of the TB to the identified HARQ process, and instruct the identified HARQ process to trigger a new transmission if: (1) the UL grant is a configured UL grant; (2) the automaticTx-LTM is configured; (3) the previous UL grant for the same HARQ process is for sending the very first UL transmission for the LTM; (4) the LTM is not considered complete; and (5) none of the PUSCH transmissions scheduled with CS-RNTI and/or C-RNTI of the obtained MAC PDU have been performed.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

In a first aspect, a method for providing early timing advance (TA) acquisition, comprising: receiving, from a base station, a radio resource control (RRC) configuration of the early TA acquisition; receiving, from the base station, a PDCCH order to trigger a random access channel (RACH) toward a candidate cell; initiating the RACH procedure for the early TA acquisition based on the received RRC configuration and PDCCH order; and transmitting, to the base station, a preamble with a calculated transmission power on the candidate cell.

A second aspect includes the method of aspect 1 wherein the PDCCH order comprises at least one of the following indications: a transmission type indication that indicates whether the preamble is a retransmission or an initial transmission; a preamble ID to indicate the preamble used for the RACH procedure for early TA acquisition; an LTM candidate Id to indicate the candidate cell where the preamble is transmitted; an SSB Id to indicate the SSB that the preamble transmission has a quasi-colocation (QCL) relationship with; or an RO Mask Index to indicate RACH occasions for the preamble transmission.

A third aspect includes the method of any preceding aspect, wherein the initiating of the RACH procedure toward a candidate cell further comprises: determining that the PDCCH order indicates an initial transmission of the preamble, then setting a counter associated the candidate cell to 1; and determining that the PDCCH order indicates a retransmission of the preamble for a candidate cell, then keeping the counter value the same.

A fourth aspect includes the method of any preceding aspect, wherein the initiating of the RACH procedure toward a candidate cell further comprises: determining that the PDCCH order indicates an initial transmission of the preamble; then setting a counter to 1; and determining that the PDCCH order indicates a retransmission of the preamble and the candidate cell is the same candidate cell a previous RACH procedure was toward, then keeping the counter value the same.

A fifth aspect includes the method of any preceding aspect, wherein the transmitting of the preamble on a candidate cell further comprises: determining that the PDCCH order indicates a retransmission of the preamble; incrementing a counter associated with the candidate cell by 1; and setting a target power for preamble transmission on the candidate cell based on the counter.

A sixth aspect includes the method of any preceding aspect, wherein the transmitting of the preamble on a candidate cell further comprises: determining that the PDCCH order indicates a retransmission of the preamble and a previous RACH procedure is for the same candidate cell; incrementing a counter by 1; and setting a target power for preamble transmission on the candidate cell based on the counter.

A seventh aspect includes the method of any preceding aspect, further comprising: determining the RACH for TA acquisition toward a candidate cell is complete upon at least one of the following: the transmission of the indicated preamble in PDCCH order is instructed to the lower layer; an LTM Cell switch MAC CE for triggering the LTM is received; the RACH for TA acquisition toward a different candidate cell is triggered; or the RRC configuration of the candidate cell is released.

An eighth aspect includes A method for providing an uplink (UL) grant for a Dedicated Control Channel (DCCH) message, comprising: receiving a Radio Resource Control (RRC) configuration of L1/L2 triggered mobility (LTM) from a source cell; receiving an LTM Cell Switch Command MAC CE from the source cell; applying the RRC configuration of an LTM candidate cell indicated by the LTM Cell Switch Command MAC CE; generating an DCCH message in response to the RRC configuration of the LTM candidate cell; transmitting a very first transmission to a target cell; and determining that LTM is successfully complete.

A ninth aspect includes the method of aspect 8, wherein transmitting the very first transmission further comprises: based on the RRC configuration and LTM Cell Switch MAC CE: transmitting the very first transmission with a dynamic grant (DG).

A tenth aspect includes the method of aspect 8 or 9, wherein transmitting the very first transmission further comprises: based on the RRC configuration and LTM Cell Switch MAC CE: transmitting the very first transmission with a configured grant (CG).

An eleventh aspect includes the method of aspects 8-10, wherein transmitting the very first transmission further comprises: based on the RRC configuration and LTM Cell Switch MAC CE, initiating RACH procedure for LTM.

A twelfth aspect includes the method of aspects 8-11, wherein the RRC configuration further comprises a ConfiguredGrantConfig that configures a number of predefined UL grant resources to be used for UL data transmission.

A thirteenth aspect includes the method of aspects 8-12, wherein for a UL grant resources assigned by ConfiguredGrantConfig and contained in the RRC configuration, only data from a logical channel configured with a Logical Channel (LCH) restriction can be multiplexed and assembled.

A fourteenth aspect includes the method of aspects 8-13, wherein the UL grant resources assigned by ConfiguredGrantConfig are ignored in case of a very first transmission for LTM has been performed and the LTM is not considered successfully completed.

A fifteenth aspect includes the method of aspects 8-14, further comprising: introducing a fallback timer for each LTM candidate.

A sixteenth aspect includes the method of aspects 8-15, further comprising: starting the fallback timer at a last symbol of PUSCH transmission for the initial transmission with a DCCH message for LTM.

A seventeenth aspect includes the method of aspects 8-16, further comprising: stopping the fallback timer upon receiving an ACK of a PUSCH transmission for an initial UL transmission.

An eighteenth aspect includes the method of aspects 8-17, further comprising: triggering RACH-based LTM upon expiration of the fallback timer.

A nineteenth aspect includes the method of aspects 8-18, further comprising: triggering a fallback to RACH-based LTM based on a PDCCH order.

A twentieth aspect includes the method of aspects 8-19, wherein the RRC configuration further comprises a ConfiguredGrantConfig that configures a number of predefined UL grant resources to be used for UL data transmission.

A twenty-first aspect includes the method of aspects 8-20, further comprising: resetting a MAC entity to flush a UL buffer for a very first transmission; notifying an upper layer of the fallback; and/or initiating the RACH-based LTM toward the LTM candidate cell.

A twenty-second aspect includes the method of aspects 8-21, wherein a CG occasion predefined by configuredGrantConfig is associated with one or more beams, the LTM Cell Switch MAC CE includes a beam indication for LTM, and the method further comprises: determining: a measurement result of RSRP of the indicated beam by the LTM Cell Switch MAC CE is less than a predefined threshold, and at least one beam exists having an RSRP value that exceeds the predefined threshold; selecting a beam that exceeds the predefined threshold; and considering the corresponding configured grant (CG) valid for a very first transmission.

A twenty-third aspect includes the method of aspects 8-22, wherein a CG occasion predefined by configuredGrantConfig is associated with one or more beams, the LTM Cell Switch MAC CE includes a beam indication for LTM, and the method further comprises: determining a measurement result of RSRP of the indicated beam by the LTM Cell Switch MAC CE exceeds a predefined threshold; and considering the corresponding configured grant (CG) valid for a very first transmission.

A twenty-fourth aspect includes the method of aspects 8-23, wherein a CG occasion predefined by configuredGrantConfig is associated with one or more beams, the LTM Cell Switch MAC CE includes a beam indication for LTM, and the method further comprises: determining no SSBs exist having an RSRP value that exceeds a predefined threshold; and considering the configured grant (CG) associated with the beam indicated by the LTM Cell Switch MAC CE for a very first transmission as valid.

A twenty-fifth aspect includes the method of aspects 8-24, wherein a CG occasion predefined by configuredGrantConfig is associated with one or more beams, the LTM Cell Switch MAC CE includes a beam indication for LTM, and the method further comprises: determining no SSBs exist having an RSRP value that exceeds a predefined threshold; and randomly selecting an SSB Id and considering the corresponding configured grant (CG) for a very first transmission.

A twenty-sixth aspect includes the method of aspects 8-25, further comprising: determining validity of a configured grant (CG) predefined by ConfiguredGrantConfig for automatic (re)transmission when the initial transmission of a very first transmission has been performed, comprising: the CG is associated with an SSB Id that is the same as the initial transmission of the very first transmission; the CG is associated with an SSB Id for which an RSRP measurement result exceeds a predefined threshold; and/or the CG is associated with a same HARQ process ID as for the initial transmission of very first transmission.

A twenty-seventh aspect includes the method of aspects 8-26, further comprising: for each valid configured grant (CG), processing the configured UL grant for automatic transmission or retransmission of a very first transmission.

A twenty-eighth aspect includes the method of aspects 8-27, wherein the RRC configuration further comprises a ConfiguredGrantConfig that configures a number of predefined UL grant resources to be used for UL data transmission, and the ConfiguredGrantConfig specifies a retransmission timer that indicates an automatic retransmission of a very first transmission with the CG is supported.

A twenty-ninth aspect includes the method of aspects 8-28, further comprising: for each CG, considering a new data indicator (NDI) value of the CG as not toggled if: the retransmission timer is configured and not running; a CG timer is running; and a previous CG having a same HARQ process ID is for sending a very first transmission for LTM.

A thirtieth aspect includes the method of aspects 8-29, wherein the ConfiguredGrantConfig specifies a parameter that allows automatic transmission of a very first transmission.

A thirty-first aspect includes the method of aspects 8-30, further comprising: for each UL grant, a HARQ entity: considers a MAC PDU for a HARQ process ID as identified, delivers the MAC PDU, the UL grant, and HARQ information of a transport block to the identified HARQ process, and instructs the identified HARQ process to trigger a new transmission when: the UL grant is a configured UL grant; the parameter is configured; a previous UL grant for the same identified HARQ process is for sending the very first transmission for the LTM completion; the LTM is incomplete; and none of a plurality of PUSCH transmissions scheduled with CS-RNTI of the MAC PDU have been performed.

A thirty-second aspect includes a method for providing early timing advance (TA) acquisition in a User Equipment (UE), comprising: receiving, from a source cell, a L1/L2 Triggered Mobility (LTM) Cell Switch MAC CE; determining TA values to be maintained during the LTM; and transmitting to a target cell with the maintained TA value.

A thirty-third aspect includes the method of aspect 32, wherein the LTM is RACH-based LTM, and the determining the TA values to be maintained during the LTM further comprises: determining valid TAs of all serving cells are invalid and will not be maintained.

A thirty-fourth aspect includes the method of aspects 32 or 33, wherein the LTM is RACH-less LTM, and the determining the TA values to be maintained during the LTM further comprises: determining valid TAs of all serving cells are valid and will be maintained.

A thirty-fifth aspect includes the method of aspects 32-34, wherein the determining the TA values to be maintained during the LTM further comprises: indicating the TA values to be maintained in the LTM Cell Switch MAC CE, comprising: indicating a TAG ID for an i-th TAG for which the TA value is present in a cell that is still a serving cell, wherein the TA value of the i¬-th TAG is an absolute TA value.

A thirty-sixth aspect includes the method of aspects 32-35, wherein the determining the TA values to be maintained during the LTM further comprises: obtaining the TA values to be maintained from an association with a TAG by an indication from RRC signaling and/or the LTM Cell Switch MAC CE.

A thirty-seventh aspect includes the method of aspects 32-36, wherein the transmitting to the target cell with the maintained TA value further comprises: applying the TA values to be maintained; and associating a new TAG with a time alignment timer (TAT) after applying the TA values.

A thirty-eighth aspect includes the method of aspects 32-37, further comprising: starting and/or restarting the TAT with remaining values of the TAT associated with a TAG belonging to a same cell.

A thirty-ninth aspect includes the method of aspects 32-38, further comprising: starting and/or restarting the TAT for each TAG when applying the TA value for a TAG indicated by either the LTM Cell Switch MAC CE or RRC signaling.

1. A method for providing early timing advance (TA) acquisition, comprising:
receiving, from a base station, a radio resource control (RRC) configuration of the early TA acquisition;
receiving, from the base station, a physical downlink control channel (PDCCH) order for triggering a random access channel (RACH) procedure for the early TA acquisition toward a candidate cell;
initiating the RACH procedure for the early TA acquisition toward the candidate cell based on the received RRC configuration and the PDCCH order;
transmitting, to the base station, a preamble indicated in the PDCCH order with a calculated transmission power on the candidate cell; and
determining that the RACH procedure for the early TA acquisition toward the candidate cell has completed at least when the transmission of the preamble in the PDCCH order is instructed to a lower layer.

2. The method of claim 1, wherein the PDCCH order comprises at least one of:
a transmission type indication that indicates whether the preamble is a retransmission or an initial transmission;
a preamble ID to indicate the preamble used for the RACH procedure for the early TA acquisition;
an LTM candidate Id to indicate the candidate cell where the preamble is transmitted toward;
or
a physical RACH (PRACH) Mask Index to indicate RACH occasions for the transmission of the preamble.

3. The method of claim 1, wherein initiating of the RACH procedure toward the candidate cell further comprises:
when determining that the PDCCH order indicates an initial transmission of the preamble, setting a value of a power ramping counter to 1; and
when determining that the PDCCH order indicates a retransmission of the preamble for a candidate cell, keeping the value of the power ramping counter unchanged.

4. The method of claim 1, wherein initiating the RACH procedure towards the candidate cell further comprises:
when determining that the PDCCH order indicates an initial transmission of the preamble, setting a value of a power ramping counter to 1.

5. The method of claim 1, wherein transmitting the preamble further comprises:
when determining that the PDCCH order indicates a retransmission of the preamble:
incrementing a value of a power ramping counter by 1; and
setting a target power for transmitting the preamble based on the value of the power ramping counter.

6. The method of claim 1, wherein transmitting the preamble further comprises:
when determining that the PDCCH order indicates a retransmission of the preamble and that a previous RACH procedure is for the same candidate cell;
increamenting a value of a power ramping counter by 1; and
setting a target power for transmitting the preamble based on the value of the power ramping counter.

7.-31. (canceled)

32. The method of claim 4, wherein initiating the RACH procedure toward the candidate cell further comprises:
when determining that the PDCCH order indicates a retransmission of the preamble and the candidate cell is the same as what a previous RACH procedure was transmitted toward, keeping the value of the power ramping counter unchanged.

33. A User Equipment (UE), comprising at least one memory for storing instructions and at least one processor for executing the instructions to:
receive, from a base station, a radio resource control (RRC) configuration of an early Timing Advance (TA) acquisition;
receive, from the base station, a physical downlink control channel (PDCCH) order for triggering a random access channel (RACH) procedure for the early TA acquisition toward a candidate cell;
initiate the RACH procedure for the early TA acquisition toward the candidate cell based on the received RRC configuration and the PDCCH order;
transmit, to the base station, a preamble indicated in the PDCCH order with a calculated transmission power on the candidate cell; and
determine that the RACH procedure for the early TA acquisition toward the candidate cell has completed at least when the transmission of the preamble in the PDCCH order is instructed to a lower layer.

34. The UE of claim 33, wherein the PDCCH order comprises at least one of:
a transmission type indication that indicates whether the preamble is a retransmission or an initial transmission;
a preamble ID to indicate the preamble used for the RACH procedure for the early TA acquisition;
an LTM candidate Id to indicate the candidate cell where the preamble is transmitted toward; or
a physical RACH (PRACH) Mask Index to indicate RACH occasions for the transmission of the preamble.

35. The UE of claim 33, wherein to initiate the RACH procedure toward the candidate cell further comprises:
when determining that the PDCCH order indicates an initial transmission of the preamble, set a value of a power ramping counter to 1; and
when determining that the PDCCH order indicates a retransmission of the preamble for a candidate cell, keep the value of the power ramping counter unchanged.

36. The UE of claim 33, wherein to initiate the RACH procedure towards the candidate cell further comprises:
when determining that the PDCCH order indicates an initial transmission of the preamble, set a value of a power ramping counter to 1.

37. The UE of claim 33, wherein to transmit the preamble further comprises:
when determining that the PDCCH order indicates a retransmission of the preamble:
increment a value of a power ramping counter by 1; and
set a target power for transmitting the preamble based on the value of the power ramping counter.

38. The UE of claim 33, wherein to transmit the preamble further comprises:
when determining that the PDCCH order indicates a retransmission of the preamble and that a previous RACH procedure is for the same candidate cell;
increment a value of a power ramping counter by 1; and
set a target power for transmitting the preamble based on the value of the power ramping counter.

39. The UE of claim 36, wherein to initiate the RACH procedure toward the candidate cell further comprises:
when determining that the PDCCH order indicates a retransmission of the preamble and the candidate cell is the same as what a previous RACH procedure was transmitted toward, keep the value of the power ramping counter unchanged.

40. A method for providing early timing advance (TA) acquisition, the method being performed by a base station and comprising:
sending, to a User Equipment (UE), a radio resource control (RRC) configuration of the early TA acquisition;
sending, to the UE, a physical downlink control channel (PDCCH) order for triggering a random access channel (RACH) procedure for the early TA acquisition toward a candidate cell;
receiving, from the UE, a preamble indicated in the PDCCH order, the preamble being sent by the UE with a calculated transmission power on a candidate cell following an initiation by the UE of the RACH procedure for the early TA acquisition towards the candidate cell based on the RRC configuration and the PDCCH order; and
determining that the RACH procedure for the early TA acquisition toward the candidate cell has completed at least when receiving the preamble on the candidate cell.

41. The method of claim 40, wherein the PDCCH order comprises at least one of:
a transmission type indication that indicates whether the preamble is a retransmission or an initial transmission;
a preamble ID to indicate the preamble used for the RACH procedure for the early TA acquisition;
an LTM candidate Id to indicate the candidate cell where the preamble is transmitted toward; or
a physical RACH (PRACH) Mask Index to indicate RACH occasions for the transmission of the preamble.

42. The method of claim 40, wherein receiving the preamble comprises:
when the PDCCH order indicates an initial transmission of the preamble, receiving the preamble transmitted by the UE with a power according to a value of a power ramping counter set to 1 at the UE; and
when the PDCCH order indicates a retransmission of the preamble for the candidate cell, receiving the preamble transmitted by the UE with a power according to the value of the power ramping counter kept unchanged at the UE.

43. The method of claim 40, wherein receiving the preamble comprises:
when the PDCCH order indicates an initial transmission of the preamble, receiving the preamble transmitted by the UE with a power according to a value of a power ramping counter set to 1 at the UE.

44. The method of claim 40, wherein receiving the preamble comprises:
when the PDCCH order indicates a retransmission of the preamble, receiving the preamble transmitted with a power according to a value of a power ramping counter incremented by 1 at the UE.

45. The method of claim 40, wherein receiving the preamble further comprises:
when the PDCCH order indicates a retransmission of the preamble and that a previous RACH procedure is for the same candidate cell, receiving the preamble transmitted with a power according to a value of a power ramping counter incremented by 1 at the UE.
